(19) United States
(12) Patent Application Publication
(10) Pub. No.: US 2026/0322555 A1
(43) Pub. Date: Oct. 15, 2026

(54) SYNCHRONIZATION SIGNAL BLOCK PARAMETERS BASED ON USER EQUIPMENT DISTRIBUTION

(71) Applicant: QUALCOMM Incorporated, San Diego, CA (US)

(72) Inventors: Srinivas YERRAMALLI, San Diego, CA (US); Vinay CHANDE, San Diego, CA (US); Arumugam CHENDAMARAI KANNAN, San Diego, CA (US)

(21) Appl. No.: 19/174,355

(22) Filed: Apr. 9, 2025

(51) Int. Cl. H04L 5/00

(52) U.S. Cl. CPC H04L 5/0051; H04L 5/0094

(57) ABSTRACT

Various aspects of the present disclosure generally relate to wireless communication. In some aspects, a user equipment (UE) may receive a synchronization signal block (SSB) of an SSB group of a plurality of SSB groups associated with respective SSB parameters in accordance with a UE distribution. The UE may receive an SSB configuration indicating the respective SSB parameters. Numerous other aspects are described.

### FIELD OF THE DISCLOSURE

Aspects of the present disclosure generally relate to wireless communication and specifically relate to techniques, apparatuses, and methods associated with synchronization signal block parameters that are based at least in part on a user equipment distribution.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A synchronization signal block (SSB) carries information that enables a user equipment (UE) to perform an initial access procedure with a network. The SSB may include resources that carry a primary synchronization signal (PSS), a secondary synchronization signal (SSS), or a physical broadcast channel (PBCH). In some examples, the PSS and SSS may enable the UE to synchronize with the network or calculate a cell identity. In some examples, the PBCH may carry system information, such as a master information block (MIB), that enables the UE to decode other system information in a physical downlink shared channel (PDSCH).

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of a synchronization signal hierarchy.

FIG. 4 is a diagram illustrating an example associated with signaling for synchronization signal block parameters that are based at least in part on a user equipment (UE) distribution.

FIG. 5 is a diagram illustrating an example process performed, for example, at a UE or an apparatus of a UE.

FIG. 6 is a diagram illustrating an example process performed, for example, at a network node or an apparatus of a network node.

FIG. 7 is a diagram of an example apparatus for wireless communication.

FIG. 8 is a diagram of an example apparatus for wireless communication.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive a synchronization signal block (SSB) of an SSB group of a plurality of SSB groups associated with respective SSB parameters in accordance with a UE distribution. The processing system may be configured to cause the UE to receive an SSB configuration indicating the respective SSB parameters.

Some aspects described herein relate to a network node. The network node may include a processing system. The processing system may include one or more processors and one or more code-storing memories coupled with the one or more processors. The processing system may be configured to cause the network node to transmit an SSB of an SSB group of a plurality of SSB groups associated with respective SSB parameters in accordance with a UE distribution. The processing system may be configured to cause the network node to transmit an SSB configuration indicating the respective SSB parameters.

Some aspects described herein relate to a method of wireless communication performed by a UE. The method may include receiving an SSB of an SSB group of a plurality of SSB groups associated with respective SSB parameters in accordance with a UE distribution. The method may include receiving an SSB configuration indicating the respective SSB parameters.

Some aspects described herein relate to a method of wireless communication performed by a network node. The method may include transmitting an SSB of an SSB group of a plurality of SSB groups associated with respective SSB parameters in accordance with a UE distribution. The method may include transmitting an SSB configuration indicating the respective SSB parameters.

Some aspects described herein relate to an apparatus for wireless communication. The apparatus may include means for receiving an SSB of an SSB group of a plurality of SSB groups associated with respective SSB parameters in accordance with a UE distribution. The apparatus may include means for receiving an SSB configuration indicating the respective SSB parameters.

Some aspects described herein relate to an apparatus for wireless communication. The apparatus may include means for transmitting an SSB of an SSB group of a plurality of SSB groups associated with respective SSB parameters in accordance with a UE distribution. The apparatus may include means for transmitting an SSB configuration indicating the respective SSB parameters.

Some aspects described herein relate to a non-transitory computer-readable medium that stores a set of instructions for wireless communication by a UE. The set of instructions, when executed by one or more processors of the UE, may cause the UE to receive an SSB of an SSB group of a plurality of SSB groups associated with respective SSB parameters in accordance with a UE distribution. The set of instructions, when executed by one or more processors of the UE, may cause the UE to receive an SSB configuration indicating the respective SSB parameters.

Some aspects described herein relate to a non-transitory computer-readable medium that stores a set of instructions for wireless communication by a network node. The set of instructions, when executed by one or more processors of the network node, may cause the network node to transmit an SSB of an SSB group of a plurality of SSB groups associated with respective SSB parameters in accordance with a UE distribution. The set of instructions, when executed by one or more processors of the network node, may cause the network node to transmit an SSB configuration indicating the respective SSB parameters.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### DETAILED DESCRIPTION

A cell can have a non-uniform user distribution due to differing characteristics of users in the cell. For example, a cell may serve users with high mobility on a road and stationary users in an office. Additionally, or alternatively, a cell may cover low-density areas (e.g., hillsides, valleys, or the like) and high-density areas (e.g., buildings). Furthermore, the user distribution of a cell may vary over time. For example, many places are active in the day and inactive at night. Without accounting for such non-uniform user distributions, an synchronization signal block (SSB) configuration for a cell serving a non-uniform user distribution may cause the network to perform excessive SSB transmissions in a given direction or at a given time for a low-density or stationary set of users, which may involve excessive computing resources (e.g., processing or memory resources) or wireless communication resources (e.g., time or frequency resources) at the network, or power consumption at a user equipment (UE). Additionally, or alternatively, the SSB configuration may cause the network to perform insufficient SSB transmissions in a given direction or at a given time for a high-density or high-mobility set of users, which may lead to the users being underserved. For example, a UE may use excessive computing resources (e.g., processing or memory resources) or wireless communication resources (e.g., time or frequency resources) due to high latency or repeated attempts to communicate with the network.

Various aspects relate generally to SSB transmission and adaptation based at least in part on a user distribution. Some aspects more specifically relate to configuring one or more SSB parameters, such as a periodicity or offset of an SSB group, in accordance with the user distribution. For example, the network may select an SSB group of a plurality of SSB groups based at least in part on the SSB parameters of the SSB group in addition to the user distribution. In some aspects, the one or more SSB parameters may be signaled via a PBCH or mapped to a PSS, an SSS, a PBCH demodulation reference signal (DMRS) sequence, a frequency raster offset, or the like. In some aspects, the SSB configuration may be adapted based at least in part on a change in the user distribution. For example, a beam shape, periodicity, or offset of the SSB group may be updated over time. In some examples, the SSB configuration may be adapted based at least in part on random access channel (RACH) statistics, user location information, or an output of a network digital twin.

Particular aspects of the subject matter described in this disclosure can be implemented to realize one or more of the following potential advantages. In some examples, the described techniques can be used to help improve computing or wireless communication resource utilization. For example, SSB transmission based at least in part on user distribution may enable the network to decrease SSB transmissions in a given direction or at a given time for a low-density or stationary set of users. As a result, the network may reduce computing or wireless communication resources allocated for the SSB transmissions directed to low-density or stationary users, and one or more low-density or stationary UEs may perform measurements less frequently, thereby improving measurement periods lengths and reducing UE power consumption. Additionally, or alternatively, the SSB transmission based at least in part on user distribution may enable the network to increase SSB transmissions in a given direction or at a given time for a high-density or high-mobility set of users. As a result, UEs in high-density or high-mobility regions may identify SSBs and connect to the network quickly, and continue to measure SSBs frequently. For example, such UEs may reduce computing resources (e.g., processing or memory resources) or wireless communication resources (e.g., time or frequency resources) that would otherwise be used due to high latency or repeated attempts to communicate with the network. Additionally, or alternatively, SSB transmission based at least in part on user distribution may help to improve flexibility to SSB transmissions (e.g., in terms of beam shape or coverage). For example, a quantity of SSBs per cell may be greater than the quantity of SSB lots within a small time interval. The SSB configuration being adaptable may enable the network or UE to achieve such potential advantages over time (e.g., in the event of a change in the user distribution). In some examples, the SSB configuration being adapted infrequently, and, thus, with tolerable overhead and only minor interruptions in wireless communication.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

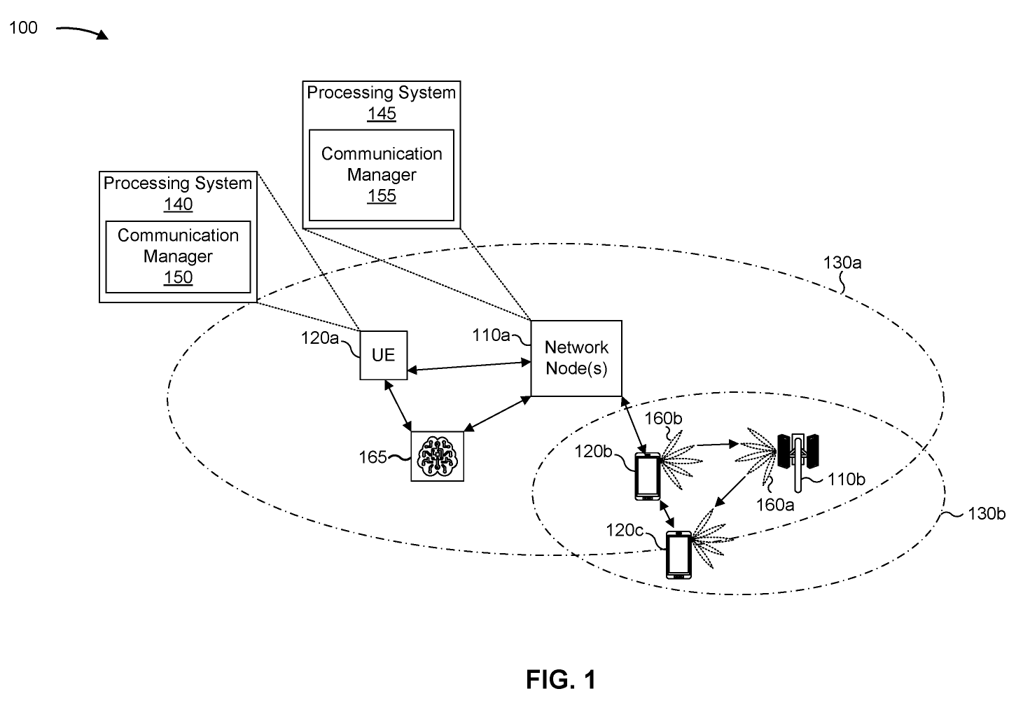

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a PSS, a SSS, an SSB (for example, that includes a PSS, an SSS, and a PBCH), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive an SSB of an SSB group of a plurality of SSB groups associated with respective SSB parameters in accordance with a UE distribution; and receive an SSB configuration indicating the respective SSB parameters. Additionally, or alternatively, the communication manager 150 may perform one or more other operations described herein.

In some aspects, the network node 110 may include a communication manager 155. As described in more detail elsewhere herein, the communication manager 155 may transmit an SSB of an SSB group of a plurality of SSB groups associated with respective SSB parameters in accordance with a UE distribution; and transmit an SSB configuration indicating the respective SSB parameters. Additionally, or alternatively, the communication manager 155 may perform one or more other operations described herein.

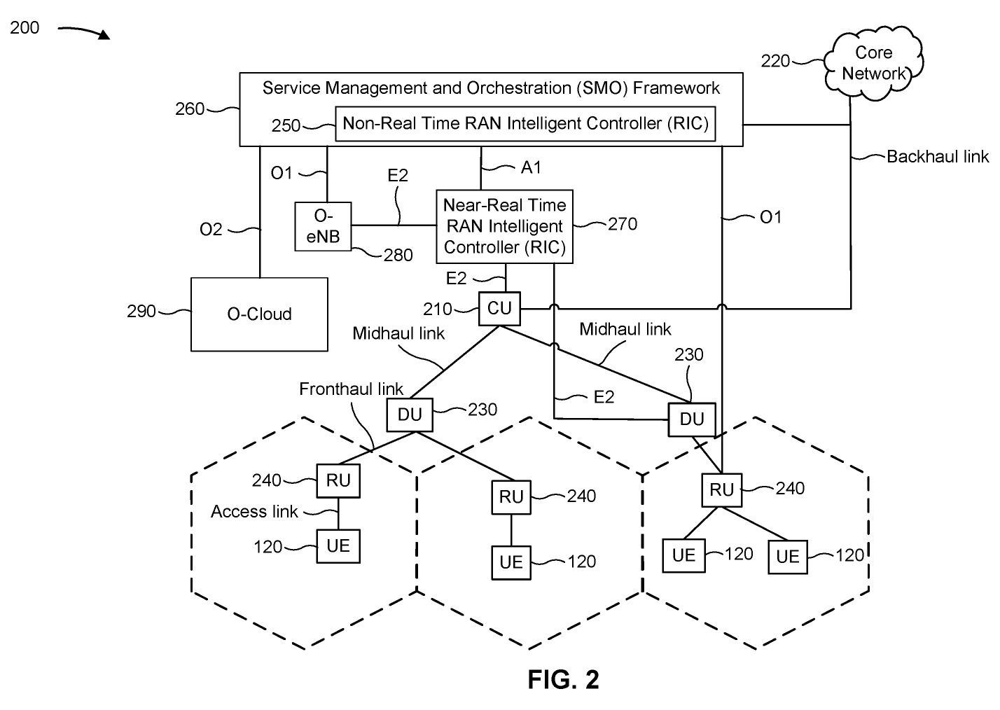

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

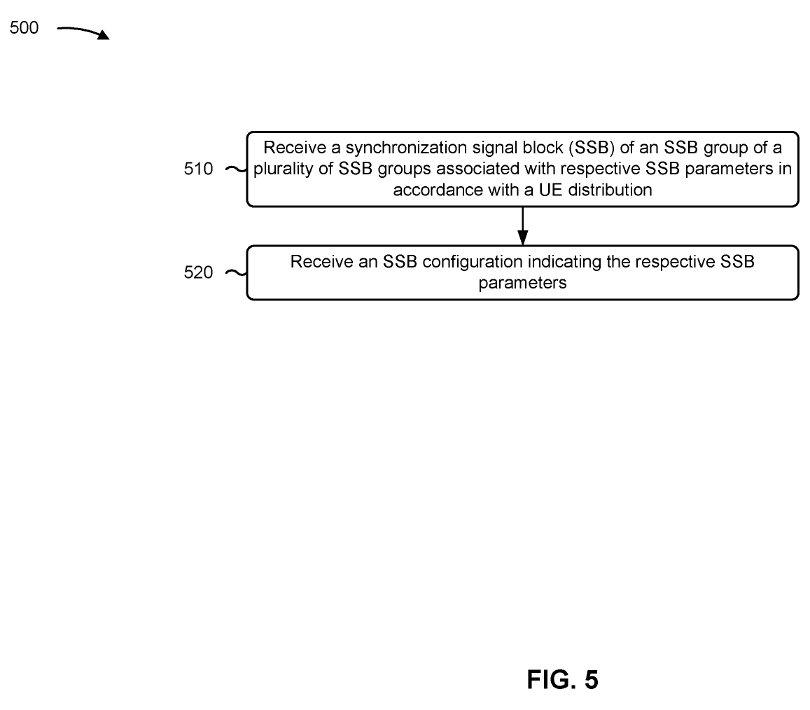

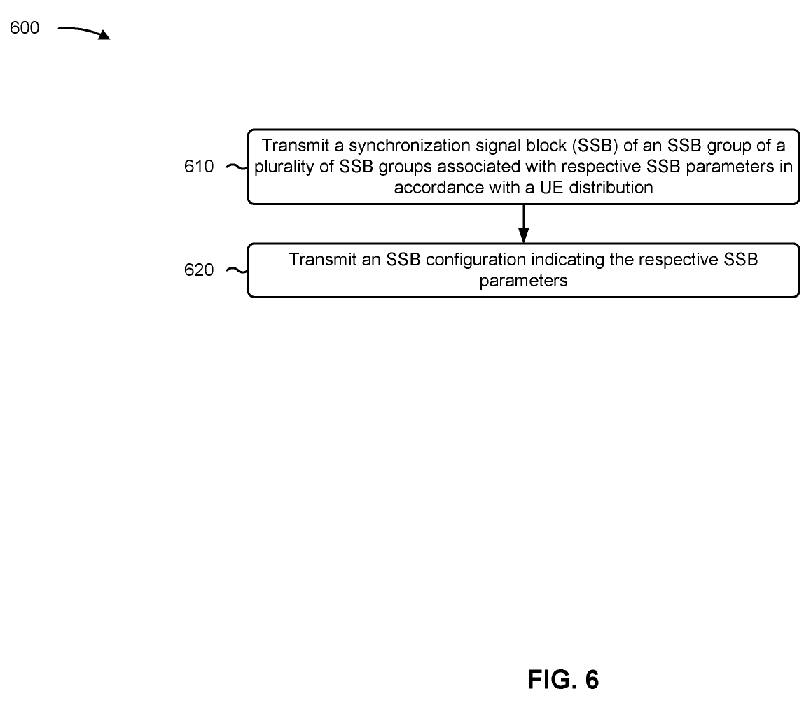

The network node 110, the processing system 145 of the network node 110, the UE 120, the processing system 140 of the UE 120, the CU 210, the DU 230, the RU 240, or any other component(s) of FIGS. 1 or FIG. 2 may implement one or more techniques or perform one or more operations associated with UE-distribution-based SSB parameters, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

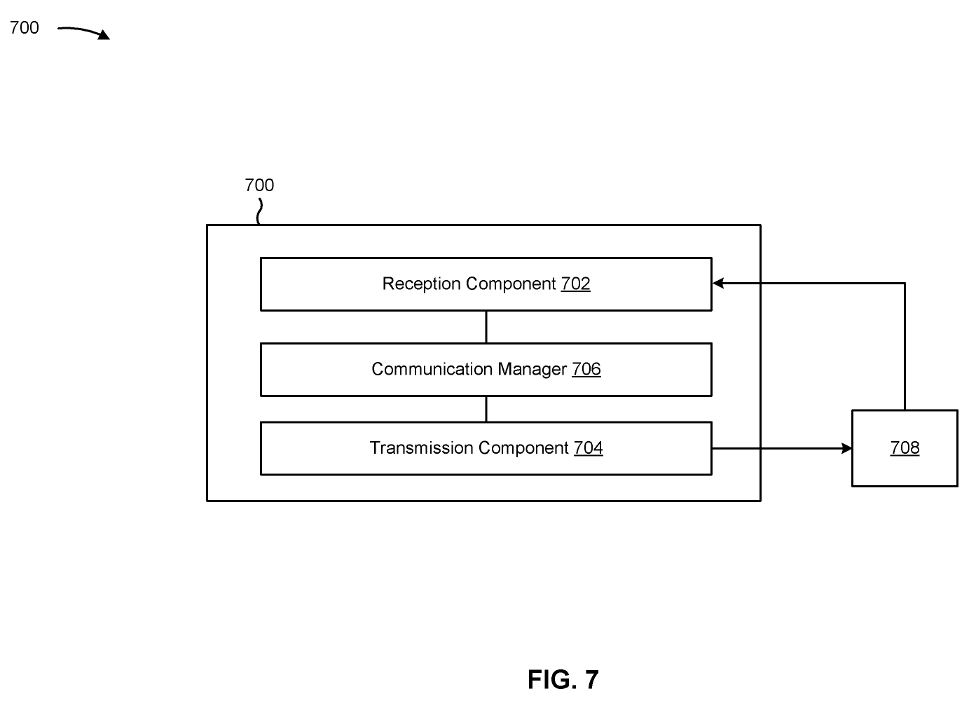

In some aspects, the UE 120 includes means for receiving an SSB of an SSB group of a plurality of SSB groups associated with respective SSB parameters in accordance with a UE distribution; or means for receiving an SSB configuration indicating the respective SSB parameters. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

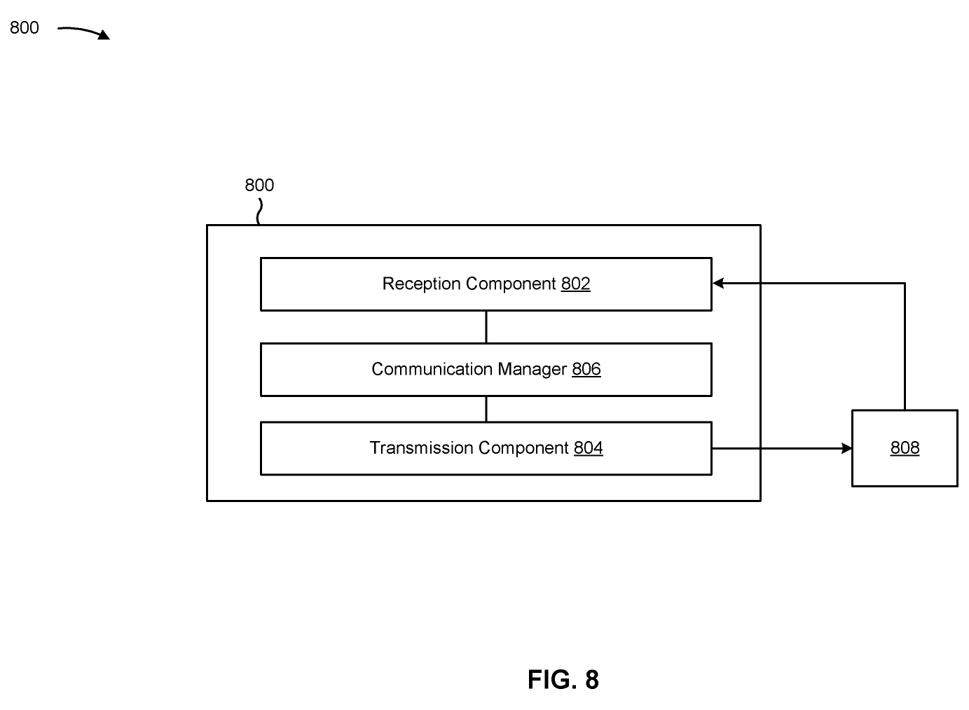

In some aspects, the network node 110 includes means for transmitting an SSB of an SSB group of a plurality of SSB groups associated with respective SSB parameters in accordance with a UE distribution; or means for transmitting an SSB configuration indicating the respective SSB parameters. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

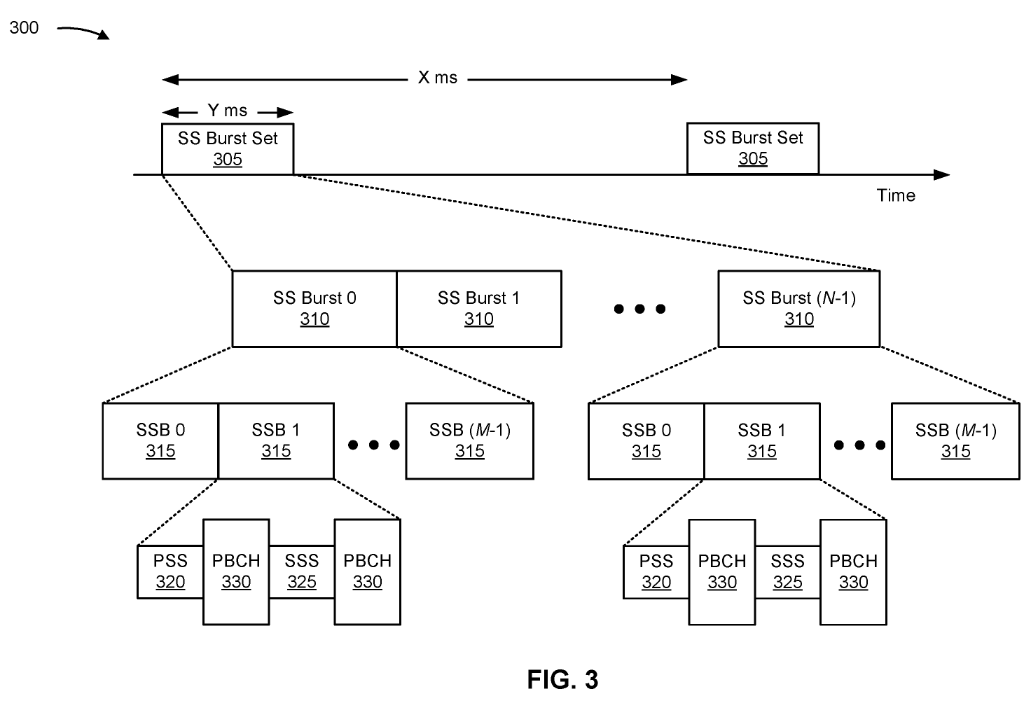

FIG. 3 is a diagram illustrating an example 300 of a synchronization signal (SS) hierarchy. As shown in FIG. 3, the SS hierarchy may include an SS burst set 305, which may include multiple SS bursts 310, shown as SS burst 0 through SS burst N-1, where N is a maximum number of repetitions of the SS burst 310 that may be transmitted by one or more network nodes. As further shown, each SS burst 310 may include one or more SSBs 315, shown as SSB 0 through SSB M-1, where M is a maximum number of SSBs 315 that can be carried by an SS burst 310. In some aspects, different SSBs 315 may be beam-formed differently (e.g., transmitted using different beams), and may be used for cell search, cell acquisition, beam management, or beam selection (e.g., as part of an initial network access procedure). An SS burst set 305 may be periodically transmitted by a wireless node (e.g., a network node 110), such as every X milliseconds, as shown in FIG. 3. In some aspects, an SS burst set 305 may have a fixed or dynamic length, shown as Y milliseconds in FIG. 3. In some cases, an SS burst set 305 or an SS burst 310 may be referred to as a discovery reference signal (DRS) transmission window or an SSB measurement time configuration (SMTC) window.

In some aspects, multiple SSBs 315 are included in an SS burst 310 (e.g., with transmission on different beams), and the PSS 320, the SSS 325, or the PBCH 330 may be the same across each SSB 315 of the SS burst 310. In some aspects, a single SSB 315 may be included in an SS burst 310. In some aspects, the SSB 315 may be at least four symbols (e.g., OFDM symbols) in length, where each symbol carries one or more of the PSS 320 (e.g., occupying one symbol), the SSS 325 (e.g., occupying one symbol), or the PBCH 330 (e.g., occupying two symbols). In some aspects, an SSB 315 may be referred to as an SS/PBCH block.

In some aspects, the symbols of an SSB 315 are consecutive, as shown in FIG. 3. In some aspects, the symbols of an SSB 315 are non-consecutive. Similarly, in some aspects, one or more SSBs 315 of the SS burst 310 may be transmitted in consecutive radio resources (e.g., consecutive symbols) during one or more slots. Additionally, or alternatively, one or more SSBs 315 of the SS burst 310 may be transmitted in non-consecutive radio resources.

In some aspects, the SS bursts 310 may have a burst period, and the SSBs 315 of the SS burst 310 may be transmitted by a wireless node (e.g., a network node 110) according to the burst period. In this case, the SSBs 315 may be repeated during each SS burst 310. In some aspects, the SS burst set 305 may have a burst set periodicity, whereby the SS bursts 310 of the SS burst set 305 are transmitted by the wireless node according to the fixed burst set periodicity. In other words, the SS bursts 310 may be repeated during each SS burst set 305.

In some aspects, an SSB 315 may include an SSB index, which may correspond to a beam used to carry the SSB 315. A UE 120 may monitor for or measure SSBs 315 using different receive (Rx) beams during an initial network access procedure or a cell search procedure, among other examples. Based at least in part on the monitoring or measuring, the UE 120 may indicate one or more SSBs 315 with a best signal parameter (e.g., an RSRP parameter) to a network node 110 (e.g., directly or via one or more other network nodes). The network node 110 and the UE 120 may use the one or more indicated SSBs 315 to select one or more beams to be used for communication between the network node 110 and the UE 120 (e.g., for a random access channel (RACH) procedure). Additionally, or alternatively, the UE 120 may use the SSB 315 or the SSB index to determine a cell timing for a cell via which the SSB 315 is received (e.g., a serving cell).

As indicated above, FIG. 3 is provided as an example. Other examples may differ from what is described with regard to FIG. 3.

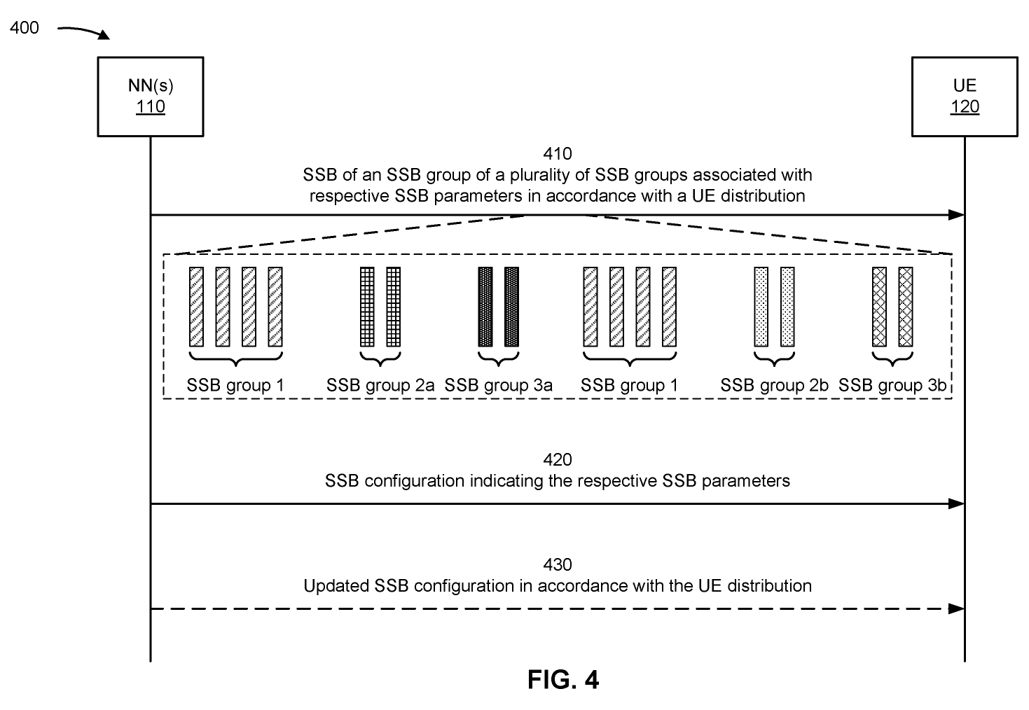

FIG. 4 is a diagram illustrating an example 400 associated with signaling for UE-distribution-based SSB parameters. As shown in FIG. 4, a network node 110 and a UE 120 may communicate with one another.

As shown by reference number 410, the network node 110 may transmit, and the UE 120 may receive, an SSB of an SSB group of a plurality of SSB groups associated with respective SSB parameters in accordance with a UE distribution. An SSB group may include one or more SSBs transmitted according to one or more SSB parameters, which may indicate one or more time or frequency resources in which the SSB(s) are to be transmitted. For example, the plurality of SSB groups may be associated with respective time or frequency resources that can carry SSBs. The UE distribution may be a physical distribution of UEs within a cell of the network node 110. For example, network node 110 may transmit the SSB based at least in part on the physical distribution of UEs within the cell. For example, the network node 110 may transmit SSBs of the SSB group in a given direction or at a given time infrequently for a low-density or stationary set of UEs in the UE distribution, or the network node 110 may transmit SSBs of the SSB group in a given direction or at a given time frequently for a high-density or mobile set of UEs in the UE distribution. In some examples, the network node 110 may apply analog beamforming for the SSB transmission based at least in part on the UE distribution.

In some aspects, the respective SSB parameters may include one or more of SSB group periodicities or SSB group offsets. For example, the plurality of SSB groups may be associated with respective SSB group periodicities or SSB group offsets. For example, the network node 110 may select, based at least in part on the UE distribution, the SSB group from among N SSB groups of the plurality of SSB groups, where each of the N SSB groups has a different SSB group periodicity or SSB group offset. An SSB group periodicity of an SSB group may indicate a separation in time or frequency between which SSBs in the SSB group are transmitted, and an SSB group offset of an SSB group may indicate a starting time or frequency at which SSBs in the SSB group are transmitted. For example, as shown in FIG. 4, the plurality of SSB groups may include five SSB groups: SSB group 1 (having a periodicity of 5ms), SSB group 2a (having a periodicity of 20ms and an offset of 0ms), SSB group 3a (having a periodicity of 80ms and an offset of 0ms), SSB group 2b (having a periodicity of 20ms and an offset of 1ms), and SSB group 3b (having a periodicity of 80ms and an offset of 1ms). Thus, the four SSBs in SSB group 1 are transmitted every 5ms, the two SSBs in SSB group 2a alternate with the two SSBs in SSB group 2b, and the two SSBs in SSB group 3a alternate with the two SSBs in SSB group 3b. In some examples, SSB group periodicities or SSB group offsets may be statically configured.

In some aspects, the SSB group periodicities or the SSB group offsets may be based at least in part on a plurality of cell regions associated with the plurality of SSB groups. The plurality of cell regions associated with the plurality of SSB groups in that the plurality of cell regions may be targeted by the plurality of SSB groups. For example, each SSB group or SSB may have a customize SSB group periodicity or SSB group offset depending on a region of the cell targeted by the SSB group or SSB (e.g., in accordance with the UE distribution).

In some aspects, a quantity of the plurality of SSB groups may be based at least in part on a predefined SSB group quantity threshold. For example, the quantity of the plurality of SSB groups may satisfy (e.g., be less than or equal to) the predefined SSB group quantity threshold. For example, the predefined SSB group quantity threshold may limit a maximum quantity of the plurality of SSB groups. In some aspects, a quantity of SSBs of the SSB group may be based at least in part on a predefined SSB quantity threshold. For example, the quantity of SSBs may satisfy (e.g., be less than or equal to) the predefined SSB quantity threshold. For example, the predefined SSB group quantity threshold may limit a maximum quantity of SSBs of the SSB group. In some aspects, the SSB group periodicities may be based at least in part on a predefined maximum SSB group periodicity threshold or a predefined minimum SSB group periodicity threshold. For example, SSB group periodicities may satisfy (e.g., be less than or equal to) the predefined maximum SSB group periodicity threshold or satisfy (e.g., be greater than or equal to) the predefined minimum SSB group periodicity threshold. For example, the predefined maximum SSB group periodicity threshold may limit a maximum SSB group periodicity, or the predefined minimum SSB group periodicity threshold may limit a minimum SSB group periodicity (e.g., the SSB group periodicities may fall between the maximum SSB group periodicity threshold and the minimum SSB group periodicity threshold). In some examples, the predefined SSB group quantity threshold, the predefined SSB quantity threshold, the predefined maximum SSB group periodicity threshold, or the predefined minimum SSB group periodicity threshold may be predefined in a wireless communications standard.

In some aspects, the one or more SSB group periodicities may be indicated using a PBCH, a PSS, an SSS, a PBCH DMRS sequence or tone, or a frequency raster offset. In some examples, the PBCH may be associated with the cell (e.g., the SSB transmitted by the cell may include the PBCH). For example, the one or more SSB group periodicities may be indicated in a master information block (MIB) of the PBCH. In some examples, the one or more SSB group periodicities may map to the PSS, the SSS, or the PBCH DMRS sequence or tone may include. For example, one or more bits may be mapped to a choice of the PSS, the SSS, or the PBCH DMRS sequence or tone. In some examples, the frequency raster offset may be associated with (e.g., mapped to) the one or more SSB group periodicities.

As shown by reference number 420, the network node 110 may transmit, and the UE 120 may receive, an SSB configuration indicating the respective SSB parameters. The SSB configuration may include a list of SSB identifiers, SSB group periodicities, SSB group offsets, or the like. For example, the UE 120 may decode the SSB configuration (e.g., an SSB group configuration, a cell SSB configuration, or the like) based at least in part on system information received in the SSB. In some examples, the UE 120 may decode the respective SSB parameters and monitor for subsequent SSBs of the plurality of SSB groups accordingly.

In some aspects, the SSB configuration may be indicated using a system information block 1 (SIB1) or a cell-specific configuration. For example, the SSB configuration may be signaled in the SIB1, or the SSB configuration may be signaled in the cell-specific configuration. In some examples, the cell-specific configuration may be a cell-specific RRC configuration.

In some aspects, the SSB configuration may be adaptive in accordance with the UE distribution. For example, the network node 110 may adapt the SSB configuration (e.g., per cell) over time based at least in part on a change in the UE distribution. Thus, the UE distribution may assist with SSB configuration adaptation based at least in part on user dynamics. In some examples, the network node 110 may change a beam shape, an SSB group periodicity, an SSB group offset, or the like.

In some aspects, the SSB configuration may be adaptive based at least in part on one or more RACH statistics associated with one or more SSBs of the plurality of SSB groups, UE location information, or an estimated UE distribution. The RACH statistics may be associated with one or more SSBs in that the RACH statistics may be collected (e.g., by the network node 110) for each of the SSBs. For example, the network node 110 may determine whether or not, or how, to fine-tune the SSB configuration using the RACH statistics. In some examples, the UE location information may indicate a physical distribution of UEs within the cell. For example, the network node 110 may collect the UE location information infrequently and use the UE location information to determine whether or not, or how, to fine-tune the SSB configuration. The estimated UE distribution may be a network digital twin that models the UE distribution based at least in part on one or more inputs to the network digital twin. For example, the network node 110 may use the estimated UE distribution to determine whether or not, or how, to fine-tune the SSB configuration. In some examples, the RACH statistics or UE location information may refine the estimated UE distribution modeled by the network digital twin.

As shown by reference number 430, the network node 110 may transmit, and the UE 120 may receive, an updated SSB configuration in accordance with the UE distribution. The updated SSB configuration may indicate at least one change to the SSB configuration (e.g., a beam shape, an SSB group periodicity, an SSB group offset, or the like).

In some aspects, the updated SSB configuration may be indicated using a SIB1. For example, a SIB1 adaptation mechanism may be used to signal SSB configuration adaptation over time.

In some aspects, the updated SSB configuration may indicate one or more of an SSB group periodicity change or a beam shape change. If the updated SSB configuration indicates the SSB group periodicity change (e.g., that a periodicity of a configured SSB is to change), then the UE 120 may adapt a measurement pattern of the SSB accordingly (e.g., such that the UE 120 monitors for the SSB in accordance with the SSB group periodicity change). If the updated SSB configuration indicates the beam shape change, then the UE 120 may measure and re-associated with a different SSB.

In some aspects, the beam shape change may be associated with one or more channels associated with downlink control, uplink control, reference signals, or data. The beam shape change may be associated with the one or more channels in that a beam subject to the beam shape change may transmit one or more communications over the one or more channels. The one or more channels may be associated with downlink control, uplink control, reference signals, or data in that the one or more channels may carry downlink control signals, uplink control signals, reference signals, or data. In some aspects, the network node 110 may transmit, and the UE 120 may receive, one or more SSBs in accordance with the beam shape change and transmission configuration indicator (TCI) state information associated with the one or more channels. The TCI state information may be associated with the one or more channels in that the TCI state information may be applicable to the one or more channels. For example, if the beam shape changes, then the UE 120 may receive the TCI state information (e.g., updated TCI state information) for each of the one or more channels.

In some aspects, the beam shape change may be associated with an updated RACH configuration or one or more updated SIBs. The beam shape change may be associated with the updated RACH configuration or the one or more updated SIBs in that the beam shape change may prompt the updated RACH configuration or the one or more updated SIBs. For example, if the beam shape changes, then a corresponding RACH configuration or one or more SIBs may be updated. In some examples, the network node 110 may transmit, and the UE 120 may receive, an indication of the updated RACH configuration or the one or more updated SIBs.

In some aspects, the network node 110 may transmit, and the UE 120 may receive, an indication of an upcoming change to the SSB configuration. For example, the indication may provide an a priori signal, to connected or inactive UEs, of the updating change. In some examples, the UE 120, or one or more UEs that are searching for a cell, may be notified of the upcoming change via over-the-air signaling (e.g., using one or more bits in an SSB).

Transmitting or receiving the SSB in accordance with the UE distribution may help to improve computing or wireless communication resource utilization. For example, transmitting or receiving the SSB in accordance with the UE distribution may enable the network to decrease SSB transmissions in a given direction or at a given time for a low-density or stationary set of UEs. As a result, the network node 110 may reduce computing or wireless communication resources allocated for the SSB transmissions directed to low-density or stationary UEs, and one or more low-density or stationary UEs may perform measurements less frequently, thereby improving measurement periods lengths and reducing UE power consumption. Additionally, or alternatively, transmitting or receiving the SSB in accordance with the UE distribution may enable the network to increase SSB transmissions in a given direction or at a given time for a high-density or high-mobility set of UEs. As a result, UEs in high-density or high-mobility regions may identify SSBs and connect to the network node 110 quickly and continue to measure SSBs frequently. For example, such UEs may reduce computing resources (e.g., processing or memory resources) or wireless communication resources (e.g., time or frequency resources) that would otherwise be used due to high latency or repeated attempts to communicate with the network node 110. Additionally, or alternatively, transmitting or receiving the SSB in accordance with the UE distribution may help to improve flexibility to SSB transmissions (e.g., in terms of beam shape or coverage). For example, a quantity of SSBs per cell may be greater than the quantity of SSB lots within a small-time interval. The SSB configuration being adaptive in accordance with the UE distribution may enable the network node 110 or UE 120 to achieve such potential advantages over time (e.g., in the event of a change in the user distribution). In some examples, the SSB configuration being adapted infrequently, and, thus, with tolerable overhead and only minor interruptions in wireless communication.

As indicated above, FIG. 4 is provided as an example. Other examples may differ from what is described with respect to FIG. 4.

FIG. 5 is a diagram illustrating an example process 500 performed, for example, at a UE or an apparatus of a UE. Example process 500 is an example where the apparatus or the UE (e.g., UE 120) performs operations associated with UE-distribution-based SSB parameters.

As shown in FIG. 5, in some aspects, process 500 may include receiving an SSB of an SSB group of a plurality of SSB groups associated with respective SSB parameters in accordance with a UE distribution (block 510). For example, the UE (e.g., using reception component 702 or communication manager 706, depicted in FIG. 7) may receive an SSB of an SSB group of a plurality of SSB groups associated with respective SSB parameters in accordance with a UE distribution, as described above. In some aspects, SSBs of the SSB group may be transmitted in a given direction or at a given time infrequently for a low-density or stationary set of UEs in the UE distribution, or in a given direction or at a given time frequently for a high-density or mobile set of UEs in the UE distribution.

As further shown in FIG. 5, in some aspects, process 500 may include receiving an SSB configuration indicating the respective SSB parameters (block 520). For example, the UE (e.g., using reception component 702 or communication manager 706, depicted in FIG. 7) may receive an SSB configuration indicating the respective SSB parameters, as described above. In some aspects, the SSB configuration may include a list of SSB identifiers, SSB group periodicities, SSB group offsets, or the like.

Process 500 may include additional aspects, such as any single aspect or any combination of aspects described below or in connection with one or more other processes described elsewhere herein.

In a first aspect, the respective SSB parameters include one or more of SSB group periodicities or SSB group offsets.

In a second aspect, alone or in combination with the first aspect, the SSB group periodicities or the SSB group offsets are based at least in part on a plurality of cell regions associated with the plurality of SSB groups.

In a third aspect, alone or in combination with one or more of the first and second aspects, a quantity of the plurality of SSB groups is based at least in part on a predefined SSB group quantity threshold, a quantity of SSBs of the SSB group is based at least in part on a predefined SSB quantity threshold, or the SSB group periodicities are based at least in part on a predefined maximum SSB group periodicity threshold or a predefined minimum SSB group periodicity threshold.

In a fourth aspect, alone or in combination with one or more of the first through third aspects, the one or more SSB group periodicities are indicated using a PBCH, a PSS, a SSS, a PBCH DMRS sequence or tone, or a frequency raster offset.

In a fifth aspect, alone or in combination with one or more of the first through fourth aspects, the SSB configuration is indicated using a SIB1 or a cell-specific configuration.

In a sixth aspect, alone or in combination with one or more of the first through fifth aspects, the SSB configuration is adaptive in accordance with the UE distribution.

In a seventh aspect, alone or in combination with one or more of the first through sixth aspects, the SSB configuration is adaptive based at least in part on one or more RACH statistics associated with one or more SSBs of the plurality of SSB groups, UE location information, or an estimated UE distribution.

In an eighth aspect, alone or in combination with one or more of the first through seventh aspects, process 500 includes receiving an updated SSB configuration in accordance with the UE distribution.

In a ninth aspect, alone or in combination with one or more of the first through eighth aspects, the updated SSB configuration is indicated using a SIB1.

In a tenth aspect, alone or in combination with one or more of the first through ninth aspects, the updated SSB configuration indicates one or more of an SSB group periodicity change or a beam shape change.

In an eleventh aspect, alone or in combination with one or more of the first through tenth aspects, the beam shape change is associated with one or more channels associated with downlink control, uplink control, reference signals, or data, and process 500 includes receiving one or more SSBs in accordance with the beam shape change, and receiving TCI state information associated with the one or more channels.

In a twelfth aspect, alone or in combination with one or more of the first through eleventh aspects, the beam shape change is associated with an updated RACH configuration or one or more updated SIBs.

In a thirteenth aspect, alone or in combination with one or more of the first through twelfth aspects, process 500 includes receiving an indication of an upcoming change to the SSB configuration.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with UE-distribution-based SSB parameters.

As shown in FIG. 6, in some aspects, process 600 may include transmitting an SSB of an SSB group of a plurality of SSB groups associated with respective SSB parameters in accordance with a UE distribution (block 610). For example, the network node (e.g., using transmission component 804 or communication manager 806, depicted in FIG. 8) may transmit an SSB of an SSB group of a plurality of SSB groups associated with respective SSB parameters in accordance with a UE distribution, as described above. In some aspects, SSBs of the SSB group may be transmitted in a given direction or at a given time infrequently for a low-density or stationary set of UEs in the UE distribution, or in a given direction or at a given time frequently for a high-density or mobile set of UEs in the UE distribution.

As further shown in FIG. 6, in some aspects, process 600 may include transmitting an SSB configuration indicating the respective SSB parameters (block 620). For example, the network node (e.g., using transmission component 804 or communication manager 806, depicted in FIG. 8) may transmit an SSB configuration indicating the respective SSB parameters, as described above. In some aspects, the SSB configuration may include a list of SSB identifiers, SSB group periodicities, SSB group offsets, or the like.

Process 600 may include additional aspects, such as any single aspect or any combination of aspects described below or in connection with one or more other processes described elsewhere herein.

In a first aspect, the respective SSB parameters include one or more of SSB group periodicities or SSB group offsets.

In a second aspect, alone or in combination with the first aspect, the SSB group periodicities or the SSB group offsets are based at least in part on a plurality of cell regions associated with the plurality of SSB groups.

In a third aspect, alone or in combination with one or more of the first and second aspects, a quantity of the plurality of SSB groups is based at least in part on a predefined SSB group quantity threshold, a quantity of SSBs of the SSB group is based at least in part on a predefined SSB quantity threshold, or the SSB group periodicities are based at least in part on a predefined maximum SSB group periodicity threshold or a predefined minimum SSB group periodicity threshold.

In a fourth aspect, alone or in combination with one or more of the first through third aspects, the one or more SSB group periodicities are indicated using a PBCH, a PSS, a SSS, a PBCH DMRS sequence or tone, or a frequency raster offset.

In a fifth aspect, alone or in combination with one or more of the first through fourth aspects, the SSB configuration is indicated using a SIB1 or a cell-specific configuration.

In a sixth aspect, alone or in combination with one or more of the first through fifth aspects, the SSB configuration is adaptive in accordance with the UE distribution.

In a seventh aspect, alone or in combination with one or more of the first through sixth aspects, the SSB configuration is adaptive based at least in part on one or more RACH statistics associated with one or more SSBs of the plurality of SSB groups, UE location information, or an estimated UE distribution.

In an eighth aspect, alone or in combination with one or more of the first through seventh aspects, process 600 includes transmitting an updated SSB configuration in accordance with the UE distribution.

In a ninth aspect, alone or in combination with one or more of the first through eighth aspects, the updated SSB configuration is indicated using a SIB1.

In a tenth aspect, alone or in combination with one or more of the first through ninth aspects, the updated SSB configuration indicates one or more of an SSB group periodicity change or a beam shape change.

In an eleventh aspect, alone or in combination with one or more of the first through tenth aspects, the beam shape change is associated with one or more channels associated with downlink control, uplink control, reference signals, or data, and process 500 includes transmitting one or more SSBs in accordance with the beam shape change, and transmitting TCI state information associated with the one or more channels.

In a twelfth aspect, alone or in combination with one or more of the first through eleventh aspects, the beam shape change is associated with an updated RACH configuration or one or more updated SIBs.

In a thirteenth aspect, alone or in combination with one or more of the first through twelfth aspects, process 600 includes transmitting an indication of an upcoming change to the SSB configuration.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive an SSB of an SSB group of a plurality of SSB groups associated with respective SSB parameters in accordance with a UE distribution. The reception component 702 may receive an SSB configuration indicating the respective SSB parameters. In some aspects, the reception component 702 may receive an updated SSB configuration in accordance with the UE distribution. In some aspects, the reception component 702 may receive an indication of an upcoming change to the SSB configuration.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit an SSB of an SSB group of a plurality of SSB groups associated with respective SSB parameters in accordance with a UE distribution. The transmission component 804 may transmit an SSB configuration indicating the respective SSB parameters. In some aspects, the transmission component 804 may transmit an updated SSB configuration in accordance with the UE distribution. In some aspects, the transmission component 804 may transmit an indication of an upcoming change to the SSB configuration.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving a synchronization signal block (SSB) of an SSB group of a plurality of SSB groups associated with respective SSB parameters in accordance with a UE distribution; and receiving an SSB configuration indicating the respective SSB parameters.

Aspect 2: The method of Aspect 1, wherein the respective SSB parameters include one or more of SSB group periodicities or SSB group offsets.

Aspect 3: The method of Aspect 2, wherein the SSB group periodicities or the SSB group offsets are based at least in part on a plurality of cell regions associated with the plurality of SSB groups.

Aspect 4: The method of Aspect 2, wherein a quantity of the plurality of SSB groups is based at least in part on a predefined SSB group quantity threshold, a quantity of SSBs of the SSB group is based at least in part on a predefined SSB quantity threshold, or the SSB group periodicities are based at least in part on a predefined maximum SSB group periodicity threshold or a predefined minimum SSB group periodicity threshold.

Aspect 5: The method of Aspect 2, wherein the one or more SSB group periodicities are indicated using a physical broadcast channel (PBCH), a primary synchronization signal (PSS), a secondary synchronization signal (SSS), a PBCH demodulation reference signal (DMRS) sequence or tone, or a frequency raster offset.

Aspect 6: The method of any of Aspects 1-5, wherein the SSB configuration is indicated using a system information block 1 (SIB1) or a cell-specific configuration.

Aspect 7: The method of any of Aspects 1-6, wherein the SSB configuration is adaptive in accordance with the UE distribution.

Aspect 8: The method of Aspect 7, wherein the SSB configuration is adaptive based at least in part on one or more random access channel (RACH) statistics associated with one or more SSBs of the plurality of SSB groups, UE location information, or an estimated UE distribution.

Aspect 9: The method of Aspect 7, further comprising: receiving an updated SSB configuration in accordance with the UE distribution.

Aspect 10: The method of Aspect 9, wherein the updated SSB configuration is indicated using a system information block 1 (SIB1).

Aspect 11: The method of Aspect 9, wherein the updated SSB configuration indicates one or more of an SSB group periodicity change or a beam shape change.

Aspect 12: The method of Aspect 11, wherein the beam shape change is associated with one or more channels associated with downlink control, uplink control, reference signals, or data, the method further comprising: receiving one or more SSBs in accordance with the beam shape change; and receiving transmission configuration indicator (TCI) state information associated with the one or more channels.

Aspect 13: The method of Aspect 11, wherein the beam shape change is associated with an updated random access channel (RACH) configuration or one or more updated system information blocks (SIBs).

Aspect 14: The method of Aspect 9, further comprising: receiving an indication of an upcoming change to the SSB configuration.

Aspect 15: A method of wireless communication performed by a network node, comprising: transmitting a synchronization signal block (SSB) of an SSB group of a plurality of SSB groups associated with respective SSB parameters in accordance with a UE distribution; and transmitting an SSB configuration indicating the respective SSB parameters.

Aspect 16: The method of Aspect 15, wherein the respective SSB parameters include one or more of SSB group periodicities or SSB group offsets.

Aspect 17: The method of Aspect 16, wherein the SSB group periodicities or the SSB group offsets are based at least in part on a plurality of cell regions associated with the plurality of SSB groups.

Aspect 18: The method of Aspect 16, wherein a quantity of the plurality of SSB groups is based at least in part on a predefined SSB group quantity threshold, a quantity of SSBs of the SSB group is based at least in part on a predefined SSB quantity threshold, or the SSB group periodicities are based at least in part on a predefined maximum SSB group periodicity threshold or a predefined minimum SSB group periodicity threshold.

Aspect 19: The method of Aspect 16, wherein the one or more SSB group periodicities are indicated using a physical broadcast channel (PBCH), a primary synchronization signal (PSS), a secondary synchronization signal (SSS), a PBCH demodulation reference signal (DMRS) sequence or tone, or a frequency raster offset.

Aspect 20: The method of any of Aspects 15-19, wherein the SSB configuration is indicated using a system information block 1 (SIB1) or a cell-specific configuration.

Aspect 21: The method of any of Aspects 15-20, wherein the SSB configuration is adaptive in accordance with the UE distribution.

Aspect 22: The method of Aspect 21, wherein the SSB configuration is adaptive based at least in part on one or more random access channel (RACH) statistics associated with one or more SSBs of the plurality of SSB groups, UE location information, or an estimated UE distribution.

Aspect 23: The method of Aspect 21, further comprising: transmitting an updated SSB configuration in accordance with the UE distribution.

Aspect 24: The method of Aspect 23, wherein the updated SSB configuration is indicated using a system information block 1 (SIB1).

Aspect 25: The method of Aspect 23, wherein the updated SSB configuration indicates one or more of an SSB group periodicity change or a beam shape change.

Aspect 26: The method of Aspect 25, wherein the beam shape change is associated with one or more channels associated with downlink control, uplink control, reference signals, or data, the method further comprising: transmitting one or more SSBs in accordance with the beam shape change; and transmitting transmission configuration indicator (TCI) state information associated with the one or more channels.

Aspect 27: The method of Aspect 25, wherein the beam shape change is associated with an updated random access channel (RACH) configuration or one or more updated system information blocks (SIBs).

Aspect 28: The method of Aspect 23, further comprising: transmitting an indication of an upcoming change to the SSB configuration.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.

Aspect 30: An apparatus for wireless communication at a device, the apparatus comprising one or more memories and one or more processors coupled to the one or more memories, the one or more processors configured to cause the device to perform the method of one or more of Aspects 1-28.

Aspect 31: An apparatus for wireless communication, the apparatus comprising at least one means for performing the method of one or more of Aspects 1-28.

Aspect 32: A non-transitory computer-readable medium storing code for wireless communication, the code comprising instructions executable by one or more processors to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

Aspect 34: A device for wireless communication, the device comprising a processing system that includes one or more processors and one or more memories coupled with the one or more processors, the processing system configured to cause the device to perform the method of one or more of Aspects 1-28.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

Aspect 36: A device comprising a processing system that includes one or more processors and one or more code-storing memories coupled with the one or more processors, the processing system configured to cause the device to perform the method of one or more of Aspects 1-28.

Aspect 37: A device comprising a processing system that includes processor circuitry and code-storing memory circuitry, the processing system configured to cause the device to perform the method of one or more of Aspects 1-28.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes processor circuitry and code-storing memory circuitry, the processing system configured to cause the UE to:
receive a synchronization signal block (SSB) of an SSB group of a plurality of SSB groups associated with respective SSB parameters in accordance with a UE distribution; and
receive an SSB configuration indicating the respective SSB parameters.

2. The UE of claim 1, wherein the respective SSB parameters include one or more of SSB group periodicities or SSB group offsets.

3. The UE of claim 2, wherein the SSB group periodicities or the SSB group offsets are based at least in part on a plurality of cell regions associated with the plurality of SSB groups.

4. The UE of claim 2, wherein a quantity of the plurality of SSB groups is based at least in part on a predefined SSB group quantity threshold, a quantity of SSBs of the SSB group is based at least in part on a predefined SSB quantity threshold, or the SSB group periodicities are based at least in part on a predefined maximum SSB group periodicity threshold or a predefined minimum SSB group periodicity threshold.

5. The UE of claim 2, wherein the one or more SSB group periodicities are indicated using a physical broadcast channel (PBCH), a primary synchronization signal (PSS), a secondary synchronization signal (SSS), a PBCH demodulation reference signal (DMRS) sequence or tone, or a frequency raster offset.

6. The UE of claim 1, wherein the SSB configuration is indicated using a system information block 1 (SIB1) or a cell-specific configuration.

7. The UE of claim 1, wherein the SSB configuration is adaptive in accordance with the UE distribution.

8. The UE of claim 7, wherein the SSB configuration is adaptive based at least in part on one or more random access channel (RACH) statistics associated with one or more SSBs of the plurality of SSB groups, UE location information, or an estimated UE distribution.

9. The UE of claim 7, wherein the processing system is configured to cause the UE to:
receive an updated SSB configuration in accordance with the UE distribution.

10. The UE of claim 9, wherein the updated SSB configuration is indicated using a system information block 1 (SIB1).

11. The UE of claim 9, wherein the updated SSB configuration indicates one or more of an SSB group periodicity change or a beam shape change.

12. The UE of claim 11, wherein the beam shape change is associated with one or more channels associated with downlink control, uplink control, reference signals, or data, and wherein the processing system is configured to cause the UE to:
receive one or more SSBs in accordance with the beam shape change; and
receive transmission configuration indicator (TCI) state information associated with the one or more channels.

13. The UE of claim 11, wherein the beam shape change is associated with an updated random access channel (RACH) configuration or one or more updated system information blocks (SIBs).

14. The UE of claim 9, wherein the processing system is configured to cause the UE to:
receive an indication of an upcoming change to the SSB configuration.

15. A network node, comprising:
a processing system that includes processor circuitry and code-storing memory circuitry, the processing system configured to cause the network node to:
transmit a synchronization signal block (SSB) of an SSB group of a plurality of SSB groups associated with respective SSB parameters in accordance with a UE distribution; and
transmit an SSB configuration indicating the respective SSB parameters.

16. The network node of claim 15, wherein the respective SSB parameters include one or more of SSB group periodicities or SSB group offsets.

17. The network node of claim 16, wherein the SSB group periodicities or the SSB group offsets are based at least in part on a plurality of cell regions associated with the plurality of SSB groups.

18. The network node of claim 16, wherein a quantity of the plurality of SSB groups is based at least in part on a predefined SSB group quantity threshold, a quantity of SSBs of the SSB group is based at least in part on a predefined SSB quantity threshold, or the SSB group periodicities are based at least in part on a predefined maximum SSB group periodicity threshold or a predefined minimum SSB group periodicity threshold.

19. The network node of claim 16, wherein the one or more SSB group periodicities are indicated using a physical broadcast channel (PBCH), a primary synchronization signal (PSS), a secondary synchronization signal (SSS), a PBCH demodulation reference signal (DMRS) sequence or tone, or a frequency raster offset.

20. The network node of claim 15, wherein the SSB configuration is indicated using a system information block 1 (SIB1) or a cell-specific configuration.

21. The network node of claim 15, wherein the SSB configuration is adaptive in accordance with the UE distribution.

22. The network node of claim 21, wherein the SSB configuration is adaptive based at least in part on one or more random access channel (RACH) statistics associated with one or more SSBs of the plurality of SSB groups, UE location information, or an estimated UE distribution.

23. The network node of claim 21, wherein the processing system is configured to cause the network node to:
transmit an updated SSB configuration in accordance with the UE distribution.

24. The network node of claim 23, wherein the updated SSB configuration is indicated using a system information block 1 (SIB1).

25. The network node of claim 23, wherein the updated SSB configuration indicates one or more of an SSB group periodicity change or a beam shape change.

26. The network node of claim 25, wherein the beam shape change is associated with one or more channels associated with downlink control, uplink control, reference signals, or data, and wherein the processing system is configured to cause the network node to:
transmit one or more SSBs in accordance with the beam shape change; and
transmit transmission configuration indicator (TCI) state information associated with the one or more channels.

27. The network node of claim 25, wherein the beam shape change is associated with an updated random access channel (RACH) configuration or one or more updated system information blocks (SIBs).

28. The network node of claim 23, wherein the processing system is configured to cause the network node to:
transmit an indication of an upcoming change to the SSB configuration.

29. A method of wireless communication performed by a user equipment (UE), comprising:
receiving a synchronization signal block (SSB) of an SSB group of a plurality of SSB groups associated with respective SSB parameters in accordance with a UE distribution; and
receiving an SSB configuration indicating the respective SSB parameters.

30. A method of wireless communication performed by a network node, comprising:
transmitting a synchronization signal block (SSB) of an SSB group of a plurality of SSB groups associated with respective SSB parameters in accordance with a UE distribution; and
transmitting an SSB configuration indicating the respective SSB parameters.
